(19) United States
(12) Patent Application Publication
(10) Pub. No.: US 2014/0096692 A1
(43) Pub. Date: Apr. 10, 2014

(54) Rubber Torsion Spring and Cushion to Protect Cutter Knives in Baler

(71) Applicant: Jeffery A. Baldauf, Hesston, KS (US)

(72) Inventor: Jeffery A. Baldauf, Hesston, KS (US)

(21) Appl. No.: 14/123,368

(22) PCT Filed: Jun. 4, 2012
(86) PCT No.: PCT/US2012/040650

§ 371 Date: Dec. 2, 2013

Related U.S. Application Data
(60) Provisional application No. 61/492,904, filed on Jun. 3, 2011.

(51) Int. Cl. A01F 29/10; A01F 15/10

(52) U.S. Cl. CPC A01F 29/10; A01F 15/10
USPC 100/97

(57) ABSTRACT

Cutter apparatus for a crop material baler has a rotor carrying a series of blades and a knife bed having a series of knives, with the knives arranged to project up between the blades so that as the blades rotate, the blades pass on opposite sides of knives and sever the crop materials. The knife bed includes a cross shaft and an indexing shaft extending substantially the full width of the knife bed. Biasing mechanisms spring-load the knives. Each biasing mechanism has a roller contacting its respective knife and a roller support mounted on the indexing shaft with a rubber torsion spring. Each knife is configured to swing down about the cross shaft against the biasing force of its torsion spring in the event that an obstruction or solid object passes through the cutting zone and engages the knife.

### BACKGROUND OF THE INVENTION

1. Field of Invention

This invention relates to rotary cutter apparatus used in harvested crop balers that reduce the crop materials picked-up from the field into smaller pieces, and more particularly to a knife protection system for the cutter apparatus.

2. Description of Related Art

In stalk-like harvested crop machines, such as balers and forage wagons, there is a need to cut the inflowing harvested crop into smaller pieces before storing it. For this purpose, cutter apparatus is used to cut the incoming windrowed crop materials before charging the materials into the main baling chamber for compression into a finished bale. Typical cutting apparatus have a number of rotating blades that pass between stationary knives arranged along side each other in a row. As the blades sweep downwardly and then rearwardly through the cutting zone they pass on opposite sides of a corresponding knife and cut the crop material.

Such apparatus typically requires a knife protection system that allows the knife to be pushed out of the way if an obstruction enters the cutting area. Typical protection systems include a number of springs and cams to apply a biasing force on the knife. One example of such a protection system is disclosed in U.S. Pat. No. 6,595,123 issued to Schrag et al. A problem with some conventional protection systems of this type is the protection systems generally contain multiple pivoting components that don't often work as desired because of the dusty environment in which they operate.

### OVERVIEW OF THE INVENTION

In one embodiment, the invention is directed to cutter apparatus for a crop material baler. The cutter apparatus has a cutter rotor carrying a series of blades and a knife bed having a series of knives, with the knives arranged to project up between the blades so that as the blades rotate through a cutting zone, the blades pass on opposite sides of knives to sever the crop materials into smaller pieces. The knife bed includes a cross shaft extending substantially the full width of the knife bed and a plurality of knives mounted onto the cross shaft. The knife bed also has an indexing shaft extending substantially the full width of the knife bed, the indexing shaft being rotatably supported on the baler, and a plurality of biasing mechanisms configured to spring-load the plurality of knives. Each biasing mechanism has a roller contacting its respective knife and a roller support mounted on the indexing shaft with a rubber torsion spring. Each knife is configured to swing down about the cross shaft against the biasing force of its torsion spring in the event that an obstruction or solid object passes through the cutting zone and engages the knife.

In one embodiment, the indexing shaft is carried by a pair of crank arms located at opposite ends of the indexing shaft. The crank arms are pivoted by at least one hydraulic cylinder to pivot the indexing shaft between an unloaded knife position and a loaded knife position. When crank arms are pivoted in a first direction to pivot the indexing shaft to the loaded knife position, the torsion springs bias their roller supports toward a fully actuated position and when the crank arms are pivoted in an opposite direction to pivot the indexing shaft to the unloaded knife position, the roller supports permit the knives to retract away from the cutting zone and the plurality of blades.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a side elevational view of a baler constructed in accordance with the principles of the present invention;

FIG. 2 is an enlarged, fragmentary, longitudinal cross-sectional view through the infeed part of the baler illustrating the relationship between the pickup, cutter apparatus, packer and stuffer;

FIG. 3 is a left, front isometric view of the cutter apparatus of FIG. 2;

FIG. 4 is fragmentary isometric view of a portion of the cutter apparatus;

FIG. 5 is a side cross-sectional view of the cutter apparatus; and

FIG. 6 is side elevational view of a roller supporter and torsion spring of the cutter apparatus.

Corresponding reference characters indicate corresponding parts throughout the views of the drawings.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “front”, “rear”, “left” and “right”, are made as viewed from the side of the baler.

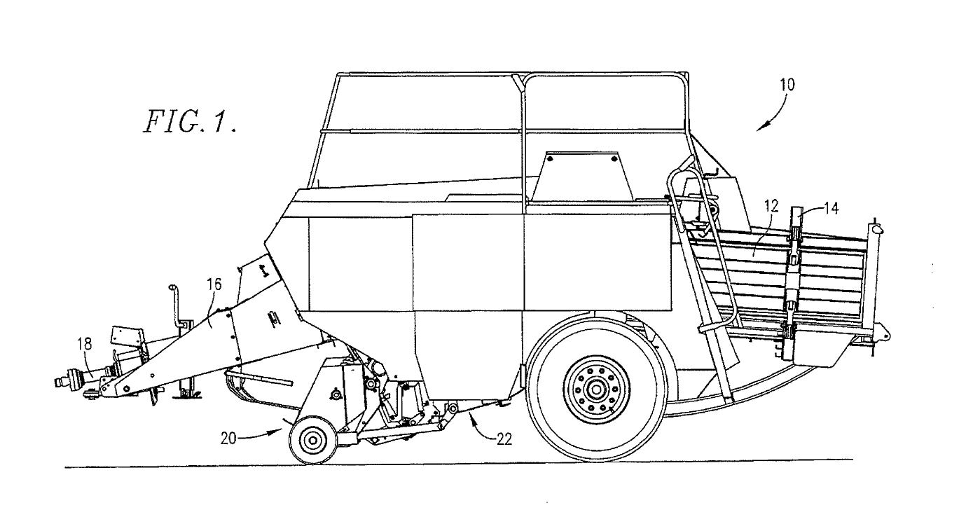

The baler 10 illustrated in FIG. 1 has a fore-and-aft extending baling chamber denoted generally by the numeral 12 within which bales of hay are prepared and forced incrementally out the back end of the chamber 12. In the illustrated embodiment, the baler 10 is an “extrusion” type baler in which the discharge orifice at the rear of the baler is of generally reduced dimensions relative to the upstream portion of the baling chamber such that the restrictive nature of the discharge orifice provides back pressure against which a reciprocating plunger within the baler can act to compress charges of hay into a bale. The dimensions of the discharge orifice and the squeeze pressure on the bales at that location are controlled by mechanism broadly denoted by the numeral 14 in FIG. 1. The baler is hitched to a towing vehicle by a fore-and-aft tongue 16, and power for operating the various components of the baler is supplied through a drive line 18 supported by the tongue 16.

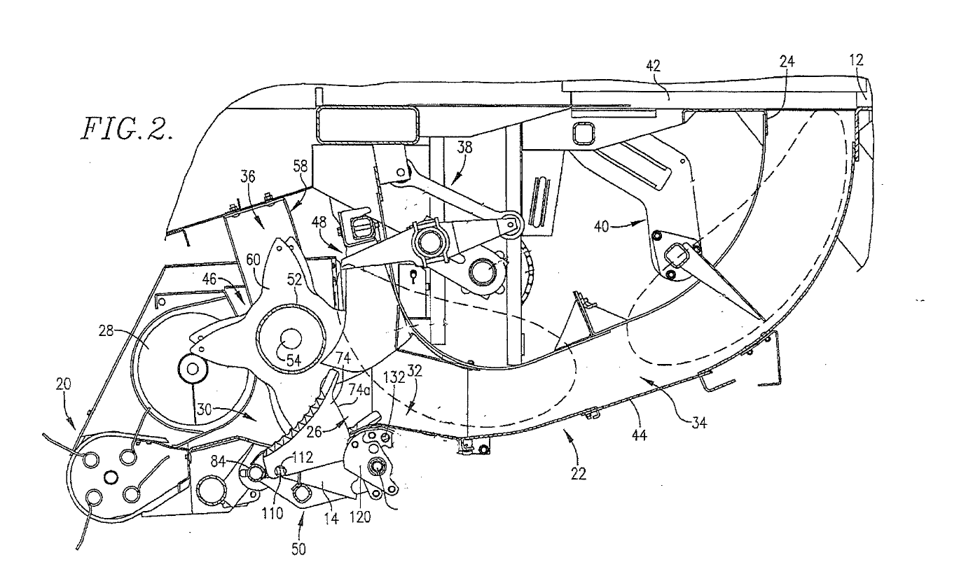

In one embodiment, the baler 10 is an “in-line” type of baler wherein crop is picked up directly beneath and slightly ahead of the baling chamber 12 and loaded up into the bottom of the chamber in a straight line path of travel as viewed from the top. As is conventional, the baler 10 has a pickup 20 positioned under the tongue 16 and in vertical registration with the baling chamber but considerably forwardly of the chamber. A duct 22 barely visible in FIG. 1 extends generally rearwardly and upwardly from behind the pickup 20 to an opening 24 (see FIG. 2) in the bottom of the baling chamber 12. The duct 22 serves as part of a passage through which crop materials travel from the pickup 20 to the baling chamber 12 during operation of the machine. In many respects, the baler 10 is similar in construction and operation to the baler as disclosed in U.S. Pat. No. 6,595,123 owned by the assignee of the present invention. Accordingly, the '123 patent is hereby incorporated by reference into the present specification.

With primary reference to FIG. 2, it will be seen that the infeed area of the baler generally comprises a passage broadly denoted by the numeral 26 for crop flow that begins just rearwardly of the pickup 20 and ends at the opening 24 in the bottom of the baling chamber 12. Although the crop materials are initially lifted off the ground by the pickup 20 in a relatively wider configuration than the width of the duct 22, such materials are immediately consolidated centrally by auger mechanism 28 before entering the passage 26. As the consolidated stream of crop materials moves rearwardly from the auger mechanism 28, it passes through a cutting zone 30 immediately behind pickup 20, then a packing zone 32 behind cutting zone 30, and finally an accumulating zone 34. Within the zone 30, the crop materials are cut into smaller pieces, within the packing zone 32 the materials have a packing and feeding force applied to them in the downstream direction of flow, and within the accumulating zone the materials accumulate into a charge that is compressed by the packing force and that assumes the configuration of the duct 22 in that area.

In order to carry out the cutting function within the cutting zone 30, the baler includes cutter apparatus broadly denoted by the numeral 36. The cutter apparatus 36 comprises three primary components, i.e., a cutter rotor 46, a bank of strippers 48 for the rotor 46, and a knife bed 50 cooperating with the rotor 46 to sever the crop materials into smaller pieces. The rotor 46 comprises a central cylindrical hub 52 having a pair of stub shafts 54 projecting from opposite ends thereof and journaled by bearings 56 mounted on a support frame 58 that is in turn suitably secured to the main chassis of the baler. A series of generally star-shaped blades 60 are affixed to the hub 52 along the length thereof for rotation with the hub 52 and the stub shafts 54 about the longitudinal axis of the stub shafts 54. The rotor 46 is driven in a counterclockwise direction viewing FIG. 2 during operation such that the blades 60 sweep downwardly into the cutting zone 30 on the front side of the axis of rotation of the rotor. In one embodiment, the bank of strippers 48 desirably comprises a series of generally upright stripping plates arranged on edge with respect to the direction of crop flow through the passage 26. However, any means for stripping the cut material from the backside of the rotor 46 as will be understood by those skilled in the art may be used. Accordingly, the bank of strippers 48 need not be discussed in further detail herein.

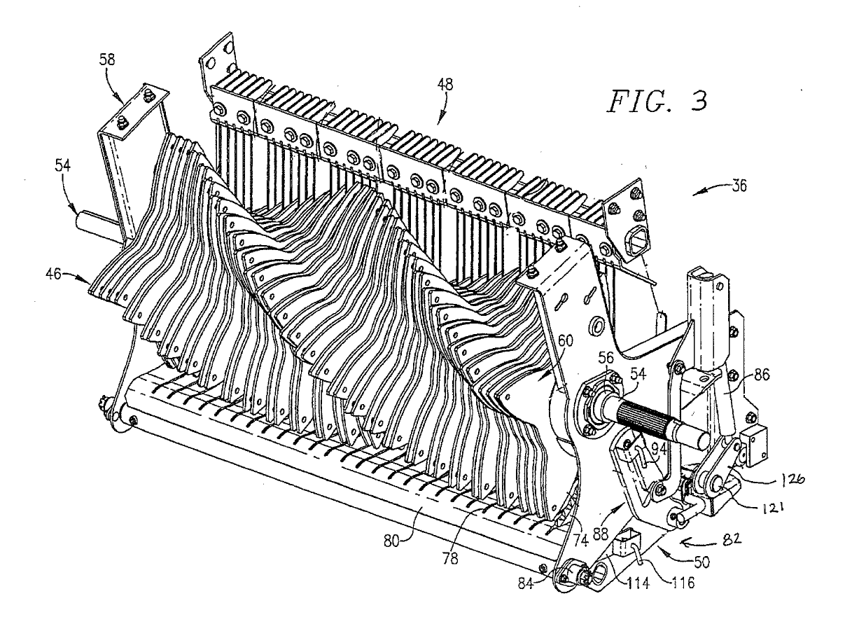

The knife bed 50 includes a series of knives 74 that cooperate with blades 60 to reduce incoming crop materials into small pieces when knives 74 are in their raised, operating positions. Knives 74 are arranged to project up between the blades 60 so that as the blades sweep downwardly and then rearwardly through the cutting zone 30 they pass on opposite sides of a corresponding knife 74. Knives 74 project up through slits 78 (FIG. 3) in a top wall 80 of the bed when knives 74 are in their operating positions.

The knives 74 are carried by a subframe 82 forming part of the bed 50. Subframe 82 is connected to the supporting frame 58 for the rotor 46 adjacent the lower forwardmost extremity of frame 58 by a transverse pivot shaft 84 so that the knife bed 50 can be raised and lowered between two extreme positions. A pair of hydraulic cylinders 86 on opposite sides of the baler 10 control raising and lowering of the knife bed 50. A latch assembly 88 on each side of the subframe 82 either retains the knife bed 50 in its raised position or allows it to be lowered to the access position depending upon whether the assembly 88 is locked or released. The latch assembly 88 may be of any means using sound engineering judgment without departing from the scope of the invention.

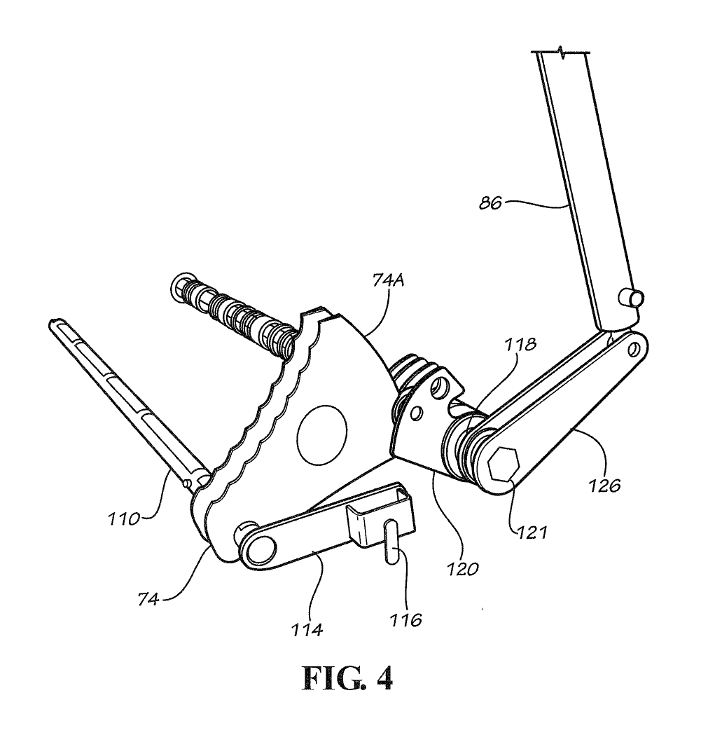

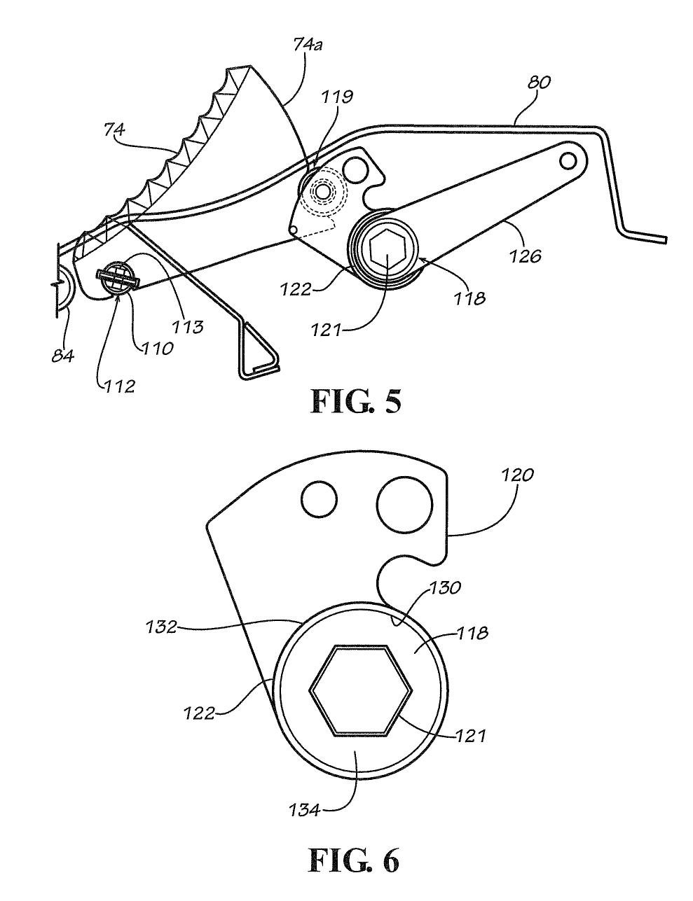

As best seen in FIGS. 4 and 5, the knives 74 are all mounted at their forward ends onto a common cross shaft 110 that extends the full width of bed 50. A generally circular notch 112 in the lower edge of each knife 74 receives the cross shaft 110. Cross shaft 110 has a pair of opposed flat sides 113 which enable each individual knife 74 to be removed from cross shaft 110 when cross shaft 110 is rotated to a position aligning the flat sides 113 thereof with the entrance into the notch 112 of the knife. At other times, the cross shaft 110 is maintained in such a rotative position that the flat sides 113 thereof are generally transverse to the entrance to the notch 112 of each knife 74 so that the knives 74 cannot be removed from cross shaft 110. A handle 114 fixed to one end of the cross shaft 110 may be manually operated to place the cross shaft 110 in the proper rotative position for either retaining or releasing the knives 74 therefrom. Suitable locking means such as a latching pin 116 may be associated with the handle 114 for use in selectively retaining the handle in knife-release or knife-retaining positions. Access to the knives 74 for removing and replacing the same is provided when the bed 50 is in its lowered position.

According to the invention, the knives 74 are all individually spring-loaded with a series of rubber torsion springs 118. Thus, if a particular knife 74 is raised up into an operating position within the cutting zone 30, the knife 74 can swing down about the cross shaft 110 against the biasing force of its torsion spring 118 in the event that an obstruction or solid object passes through the cutting zone 30 and engages the knife 74. Each torsion spring 118 engages its knife 74 through a roller 119 mounted on a generally sector-shaped roller support 120. Roller 119 may be mounted for rotation on the roller support 120 using any means known to one skilled in the art. The roller support 120 has a generally circular spring-receiving portion 122 near an end opposite the roller 119 and is pivotally mounted on an indexing shaft 121 with the torsion spring 118. The indexing shaft 121 is rotatably supported by the subframe 82 and extends across the entire width of the knife bed 50. Each roller support 120 is free to pivot independently of the others on the indexing shaft 121 and has its roller 119 mounted on near its arcuate front extremity.

As best seen in FIGS. 4 and 5, the roller 119 rides against and seats in a detent 123 in a trailing edge 74a of the corresponding knife 74. The contour of the trailing knife edge 74a and its geometrical relationship to the pivot axis of the knife 74 at shaft 110 and the pivot axis of the roller support 120 at indexing shaft 121 are such that when a knife 74 is pushed downwardly from its raised position by an obstruction or the like, the corresponding roller support 120 is rotated in a clockwise direction viewing FIGS. 2 and 5, against the biasing force of the torsion spring 118. On the other hand, when a knife 74 is in a lowered, retracted position and the corresponding roller support 120 is in its clockwise-most position, rotation of the corresponding roller support 120 counterclockwise has the effect of forcibly camming the corresponding knife 74 up into its operating position. Thus, depending upon the position for each roller support 120, the corresponding knife 74 may either be raised or lowered.

As best seen in FIG. 4, the indexing shaft 121 is carried by a pair of crank arms 126 located at opposite ends of the indexing shaft 121. The crank arms 126 are pivoted by the hydraulic cylinders 86 connected at one end of the crank arms 126. Thus, the crank arms 126 move in unison to pivot the indexing shaft 121 to change the effective anchor point for the torsion springs 118. When crank arms 126 are pivoted counter clockwise or into a fully raised position, the torsion springs 118 yieldably bias their roller supports 120 toward the fully actuated position shown in FIG. 4. However, when the crank arms 126 are pivoted in the clockwise direction or in their fully lowered positions, the roller supports 120 rotate around to their full clockwise most positions, permitting the knives 74 to retract. With knives 74 in their retracted positions and the tension in torsion springs 118 substantially released, the handle 114 may be operated to properly align the flats 113 of cross shaft 110 in the appropriate manner to allow removal of any one or all of the knives 74 from the cross shaft 110.

Turning now to FIG. 6, the outer side 130 of the torsion spring 118 is anchored to an inner portion of a collar 132 of the spring-receiving portion 122 in the lower end of the roller support 120. In one embodiment, the torsion spring 118 is bonded to the inner surface of the collar 132. However other means of providing a substantially slip-free engagement between the torsion spring 118 and the roller support 120 may be used using sound engineering judgment. At its inner side 134, the torsion spring 118 mates with or is keyed to the indexing shaft 121. As best seen in FIG. 6, the indexing shaft has a shape such that when the roller support is mounted on the indexing shaft, the inner surface of the torsion spring 118 mates with the indexing shaft 121 such that rotational movement of the indexing shaft 121 is transmitted to the torsion spring 118 and the inner surface is substantially prevented from rotating around the indexing shaft. In the illustrated embodiment, the indexing shaft 121 has a hexagonal cross-section that mates with a corresponding cross section of the inner surface of the torsion springs 118. However, one skilled in the art will understand that other keying shapes may be used for the indexing shaft and the mating interior surface of the torsion springs 118 without departing from the scope of the invention. The torsion spring 118 may have strengthening members, such as cords or belts, embedded within the body of the torsion spring, desirably oriented in a direction parallel with the axis of the indexing shaft-receiving opening in the spring to strengthen the torsion spring 118 and prevent the torsion spring from rotating around the indexing shaft 121.

As is known in the art, the number of knives 74 which are raised up into their operating position when the bed is in its operating position can be selectively varied. This can be carried out by controlling which of the roller supports 120 are allowed to rotate back into their actuated positions by the torsion springs 118 as the bed 50 is raised up into its operating position. In a preferred embodiment, this is accomplished by having the total set of roller supports 120 constructed in four different configurations that render it possible to prevent every third actuator from returning, prevent every other actuator from returning, or prevent none of the actuators from returning. In the latter situation, all of the knives are thus raised back up to their operating position. U.S. Pat. No. 6,595,123 teaches a suitable selector rod 132 for carrying out such selection of the actuators.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. Cutter apparatus for a crop material baler having a cutter rotor carrying a series of blades and a knife bed configured to work with the blades to sever the crop materials into smaller pieces, said knife bed comprising:
a cross shaft extending substantially the full width of the knife bed;
a plurality of knives mounted onto the cross shaft, wherein said knives are arranged to project up between blades on the cutter rotor so that as the series of blades rotate through a cutting zone, blades pass on opposite sides of knives;
an indexing shaft extending substantially the full width of the knife bed, said indexing shaft being rotatably supported on the baler; and
a plurality of biasing mechanisms configured to spring-load said plurality of knives, each biasing mechanism comprising a roller contacting a respective knife and a roller support mounted on said indexing shaft with a rubber torsion spring, wherein each knife is configured to swing down about the cross shaft against the biasing force of its torsion spring in the event that an obstruction or solid object passes through the cutting zone and engages said knife.

2. The cutter apparatus of claim 1 wherein each biasing mechanism is configured to individually spring-load its respective knife, such that each knife can individually swing down about the cross shaft against the biasing force of its torsion spring in the event that an obstruction or solid object passes through the cutting zone and engages the knife.

3. The cutter apparatus of claim 1 wherein the indexing shaft is configured for pivoting movement about its axis between an unloaded knife position and a loaded knife position.

4. The cutter apparatus of claim 1 wherein each roller is mounted at an arcuate front extremity of its roller support.

5. The cutter apparatus of claim 1 wherein each roller rides against and seats in a detent in a trailing edge of its corresponding knife.

6. The cutter apparatus of claim 1 wherein the indexing shaft is carried by a pair of crank arms located at opposite ends of the indexing shaft and the crank arms are pivoted by at least one hydraulic cylinder connected to said crank arms.

7. The cutter apparatus of claim 6 wherein the crank arms move in unison to pivot the indexing shaft to change between an unloaded knife position and a loaded knife position.

8. The cutter apparatus of claim 7 wherein when crank arms are pivoted in a first direction to pivot the indexing shaft to the loaded knife position, the torsion springs bias their roller supports toward a fully actuated position and when the crank arms are pivoted in an opposite direction to pivot the indexing shaft to the unloaded knife position, the roller supports permit the knives to retract away from the cutting zone and the plurality of blades.

9. The cutter apparatus of claim 1 wherein an outer side of each torsion spring is anchored to a spring-receiving collar of its respective roller support.

10. The cutter apparatus of claim 9 wherein the torsion spring is bonded to an inner surface of the collar.

11. The cutter apparatus of claim 1 wherein an inner side of each torsion spring mates with the indexing shaft.

12. The cutter apparatus of claim 1 wherein the indexing shaft has a shape such that when the roller support is mounted on the indexing shaft, the inner surface of the torsion spring mates with the indexing shaft such that rotational movement of the indexing shaft is transmitted to the torsion spring and the inner surface is substantially prevented from rotating around the indexing shaft.

13. The cutter apparatus of claim 12 wherein the indexing shaft has a hexagonal cross-section that mates with a corresponding cross section of the inner surface of the torsion springs.

14. The cutter apparatus of claim 1 wherein each torsion spring has a plurality of strengthening members embedded therein to strengthen said torsion spring and prevent said torsion spring from rotating around the indexing shaft, said strengthening members comprising members oriented in a direction parallel with an axis of an indexing shaft-receiving opening in said torsion spring.
